(19) United States
(12) Patent Application Publication
(10) Pub. No.: US 2008/0108351 A1
(43) Pub. Date: May 8, 2008

(54) Seamless transmission of media traffic for roaming mobile terminals during handoffs

(75) Inventor: Neset Arda Erol, Vancouver (CA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UT Starcom, Inc., Alameda, CA (US)

(21) Appl. No.: 11/593,934

(22) Filed: Nov. 6, 2006

(51) Int. Cl. H04Q 7/20

(52) U.S. Cl. 455/436

(57) ABSTRACT

Methods for seamless transfer of media traffic for roaming mobile terminals during hard handoffs from one base station system to another are described. In one embodiment, a base station controller forwards media traffic after handoff occurs to a second base station controller where the mobile terminal is currently registered. The second base station controller listens for media traffic from the first base station controller on one port and for traffic from the remote equipment on a second port. When traffic starts to arrive on the second port, the first port is released.

### BACKGROUND

1. Field

This invention relates generally to the field of wireless communications and more particularly to methods of providing seamless transmission of media traffic for roaming mobile terminals in the event of a handoff of the call from one base station controller to another. The disclosure further relates to a method of providing mobility hiding for a roaming mobile terminal.

2. Description of Related Art

It is known in the art that an Internet Protocol (IP) network can be used between two media gateways (MGWs) or Base Station Controllers (BSCs) or between an MGW and a BSC to carry media traffic from mobile terminals, such as cellular telephones, personal digital assistants, and the lap-top computers. Such media traffic is transported across networks in accordance with a protocol known as the Real-time Transport Protocol (RTP) as RTP streams. The Real-time Transport Protocol is a well known standard for transporting media streams in real time between endpoints such as roaming mobile devices.

As mobile devices roam over a geographic area, such roaming may trigger a handoff of communications between wireless network resources. Handoff can occur between one base transceiver station (BTS) and another, both of which are served by the same base station controller (BSC). Handoff can also occur between one BTS and another where the first BTS transceiver station is served by one BSC and the second is served by a different BSC (“inter-BSC handoff”).

In wireless networking, a mobile switching center (MSC) controls one or more MGWs and/or BSCs. There is a signaling link between the MSC and each MGW or BSC connected to it. There is also signaling between two half-MSCs, that is, where the functionality of a single MSC split into two geographically separate devices. An MSC is typically configured such that there is either one MSC controlling multiple MGWs and BSCs, or else two half-MSCs controlling multiple MGWs and BSCs.

Any inter-BSC handoff causes the source/destination addresses in the RTP user media traffic to change. This presents a problem if the signaling link between the MSC and the MGW or BSC, or between two half-MSCs and the MGW or BSC, is a slow one. In some deployments of wireless telephone networks, such signaling links may involve a relatively slow satellite link, for example in the situation where one MGW is on an island and a satellite link is used to carry signaling traffic between the MGW and an MSC which is located on the mainland.

Consider for example the situation shown in FIG. 1. One mobile device (originating mobile device) 10 is on an island 11 and is communicating with a second mobile device 20. The mobile device 10 communicates with an originating base station system (remote BSS) 12 consisting of a base station controller 14 and base transceiver station 15, via an antenna 17. The BSC 14 serving the mobile device communicates via a satellite 16 with an MSC 18 on the mainland. The second mobile device 20 (destination mobile device) is also on the island in this example. The second mobile device 20 is registered with a first “Source” BSS 21 consisting of BSC 24 and BTS 22 and communicates via an antenna 23 coupled to the BTS 22. The device 20 is roaming (to the new position 20′) such that a hard handoff occurs between the Source BSC 24 and a BSC 26 (Target BSC). The BSC 26 and BTS 30 form a second or “Target” BSS 25. Because of the delay in signaling over the satellite link 28, and in particular delay in updating the MSC 18 of the new destination address of the second BSC 26, the BSC 14 continues to stream user media from the mobile device 10 to the first (old) BSC 24. In particular, during the handoff, MSC 18 tells BSC 24 and BSC 26 to perform the handoff. BSC 26 returns an RTP port number to MSC 18. MSC 18 then sends this RTP port number and the IP address of BSC 26 to BSC 14. This is so that BSC 14 can start sending any RTP packets to BSC 26 instead of BSC 24. The first satellite delay occurs when the MSC 18 receives the RTP port number from BSC 26; the second satellite delay occurs when MSC 18 sends this RTP port number along with IP address of BSC 26 to BSC 14. (A relatively slow or high-delay signaling link using the satellite 16 may also exist where a second MSC serves the BSC 26 and inter-MSC signaling occurs via the satellite 16). Since the hard handoff has already occurred and the mobile device 20 has already registered with the second (new) BSC 26, the first BSC 24 simply drops the media packets arriving after the hard handoff occurred, in accordance with prior art techniques. The second (new) BSC 26 does not receive any user traffic for an appreciable period of time, i.e., until the BSC 14 has been given updated routing information over the slow satellite link 28 for routing media to the new BSC 26. The end result is that the mobile device 20 does not receive any media from the mobile device 10 after it has registered with the second base station system 25 for a noticeable amount of time, as such media traffic was dropped by BSC 24.

This disclosure addresses this problem and provides for methods for seamless transmission of media streams during hard handoffs between BSCs that does not have the problem with latency or dropped packets, even where there is a relatively slow or high-delay link to a MSC, e.g., in a wireless network with a satellite link in the control path.

A solution to latency problems has been proposed wherein the RTP stream is anchored on one BSC and such BSC is designated to forward the RTP stream to other BSCs during the duration of the call. In FIG. 1, this would mean that BSC 24 would send all RTP packets that it receives to BSC 26. BSC 14 would never be told about the IP address or port number change over to BSC 26. Although this solves the problem with satellite delays, the solution has one major problem, namely congestion at the designated BSC. Consider for example a major highway with drivers going back and forth making calls along the route. In this situation, there will typically be a number of BSSs spaced along the highway (BSS 1, 2, 3, . . . N), with BSS1 controlled by BSC1 and BSS N controlled by BSC N. As cars drive by, the first and last BSC (i.e., BSC1 and BSCN) become the anchor points for all RTP traffic for any call that was already in progress when that section covered by BSS1 . . . BSSN was entered. This situation can put a heavy demand on the first and last BSCs.

Aspects of this disclosure are related to a protocol known as the Media Gateway Control Protocol, which is set forth in ITU-T Recommendation H.248, the contents of which are incorporated by reference herein. Other aspects of this disclosure are also related to the interoperability specification available at 3GPP.org and 3GPP2.org. The 3GPP.org and 3GPP2.org interoperability specifications describe various signaling and media interfaces in GSM (Global System for Mobile Communications) and CDMA (Code Division Multiple Access) networks, respectively.

### SUMMARY OF THE INVENTION

In a first aspect, a method is described for seamless transmission of media traffic to a roaming mobile terminal in the event of a handoff from a first base station system (e.g., base station controller and base transceiver station, referred to herein as “Source BSS”) to a second base station system (e.g., base station controller and base transceiver station, referred to herein as “Target BSS”) due to roaming of the mobile terminal from the Source BSS to the Target BSS. The method is suitable for a communications system environment having a relatively slow or high-delay signaling path (e.g., satellite link) to an MSC, such as a system using a satellite link between the remote BSS and MSC or between the destination BSS and MSC. The roaming mobile terminal receives media traffic from a remote media equipment, which may take the form of a base station controller, media gateway, media server, or other entity generating or transmitting RTP traffic.

In a first embodiment, the Source BSS routes any additional incoming media to the Target BSS system after the hand-off has occurred until the media from the remote media equipment starts arriving at the Target BSS. This embodiment appreciates that a delay in forwarding new routing information due to the satellite link will result in some media traffic being sent to the Source BSS after the handoff has occurred. Any such traffic that is received at the Source BSS is forwarded to the Target BSS. This particular embodiment takes advantage of a communication path (e.g. LAN, WAN, microwave link, or other) between the Source and Target base station systems. Such a path will typically be present in wireless network deployments where multiple base station controllers are linked together via a LAN or other type of network (which may be configured as an Internet Protocol network).

In this embodiment, a method for seamless transmission of media traffic to a roaming mobile terminal in the event of a handoff from a first (“Source”) base station system (e.g., base station controller and base transceiver station) to a second (“Target”) base station system (e.g., base station controller and base transceiver station) due to roaming of the mobile terminal comprises the steps of:

(1) establishing a channel at the Target base station system with the mobile terminal, in response to the handoff to the Target base station system; (the radio channel on the Source base station system is torn down as usual in response to the handoff)

(2) setting up two incoming media ports at the Target base station controller, the first of which (“port 1”) comprises a media port to receive traffic from the Source base station system and the second of which (“port 2”) comprises a media port to receive traffic from the remote media equipment; (the Source base station system is instructed to route any incoming media packets for the torn down connection to port 1 on the Target base station controller. An optional timeout timer is set up at this point limiting the period of time in which Source base station system forwards packets to port 1.

(3) receiving, at the Target base station controller, any traffic received at the Source base station system at the first media port (port 1); and

(4) forwarding media traffic received on the first media port or the second media port of the Target base station controller to the roaming mobile terminal. The Target base station controller treats media traffic (packets) received at either port 1 or port 2 as if they were received on a single port.

In one particular embodiment, the Target base station controller tears down (i.e., releases) port 1 after a configurable time period T elapses after port 1 is established. In one variation, the Target base station controller tears down port 1 after a configurable time period T elapses after a first packet is received on the port 2. T may for example be the length (duration) of the jitter buffer of the Target base station controller.

In one embodiment, in the event that the media equipment is configured to handle an asymmetric Real-time Transport Protocol (one in which different source and destination addresses for RTP traffic are present for the same end of RTP traffic), the second (Target) base station controller forwards packets from the roaming mobile terminal destined for the remote media equipment (i.e., traffic in the reverse direction) in a traffic path wherein the Source base station system is not in the traffic path. In other words, traffic in the reverse direction can be transmitted from the Target base station controller directly to the remote base station system or media equipment. In this embodiment, two incoming media ports used on the Target base station system can actually be the same RTP port (i.e., they can have the same UDP port number). If identical port numbers are used, the tearing down of Port 1 as mentioned above does not apply.

In some embodiments, the remote base station or media gateway may not be configured to handle asymmetric Real-time Transport Protocol traffic. In this situation, the second base station controller forwards packets from the roaming mobile terminal destined for the remote media equipment (i.e., reverse direction traffic) in a traffic path wherein the first base station system is in the traffic path. In other words, the source and destination address for the same end of the RTP traffic is the same—that of the “Source” base station system. The traffic is routed to and from the Target base station system through the Source base station system and from there to the remote media equipment.

In another aspect of this disclosure, methods are provided for hiding mobility from remote media equipment (e.g., remote media server, media gateway, media resource function), because such remote equipment may not support mobility, e.g., changing IP addresses of base station controllers as a mobile device roams between BSCs. When the mobile terminal roams from a first base station system to a second base station system, a media port is set up at the second base station controller, for receiving traffic from the first base station system. After the handoff occurs, any further incoming media traffic received at the first base station system is forwarded to the media port at the second base station controller. Media traffic received on the media port of the second base station controller is forwarded to the mobile terminal. This embodiment is similar to the previous embodiment except that second port is not set up at the second base station controller to receive traffic directly from the media server or the other piece of remote equipment.

### BRIEF DESCRIPTION OF THE DRAWINGS

Exemplary embodiments are illustrated in referenced figures of the drawings. It is intended that the embodiments and figures disclosed herein are to be considered illustrative rather than restrictive

FIG. 1 is an illustration of a prior art arrangement showing communication elements for allowing mobile terminals to communicate with each other, including remote base station system (BSS) serving a source mobile device and first and second base station systems (BSS1 and BSS2, respectively) serving a roaming mobile terminal.

FIG. 2A is an illustration of a first embodiment of the invention with a base station controller in the first BSS forwarding media traffic after the handoff occurs to a port on the base station controller in the second BSS.

FIG. 2B is an illustration of an embodiment with a media server which forwards media traffic to a roaming mobile terminal. The media server (or one of the entities connected to it such as the mobile resource function (MRF), or the media gateway (MGW), does not support mobility. The mobility of the roaming mobile terminal is hidden from the remote equipment (media server, MRF, MGW, BSC, other) by means of a forwarding function performed at the first base station system.

FIGS. 3A and 3B are illustrations of states of Media Gateway Control Protocol physical and ephemeral terminations in the first and second base station systems providing for a seamless transition of media traffic during handoff using the features of FIG. 2A-2B. Port 1 and Port 2 may be the same RTP/UDP port in the semi-routed case.

FIG. 4 is an illustration showing the state transitions of FIGS. 3A and 3B during inter-Base Station Controller (BSC) handoffs.

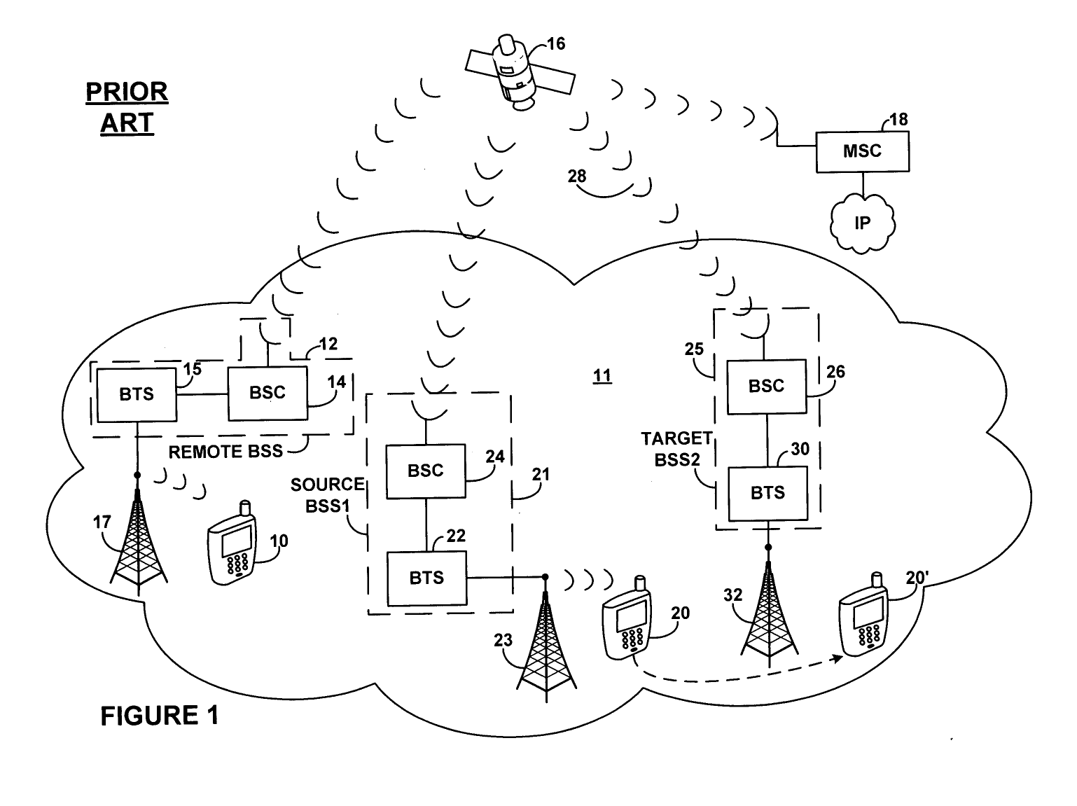

### DETAILED DESCRIPTION

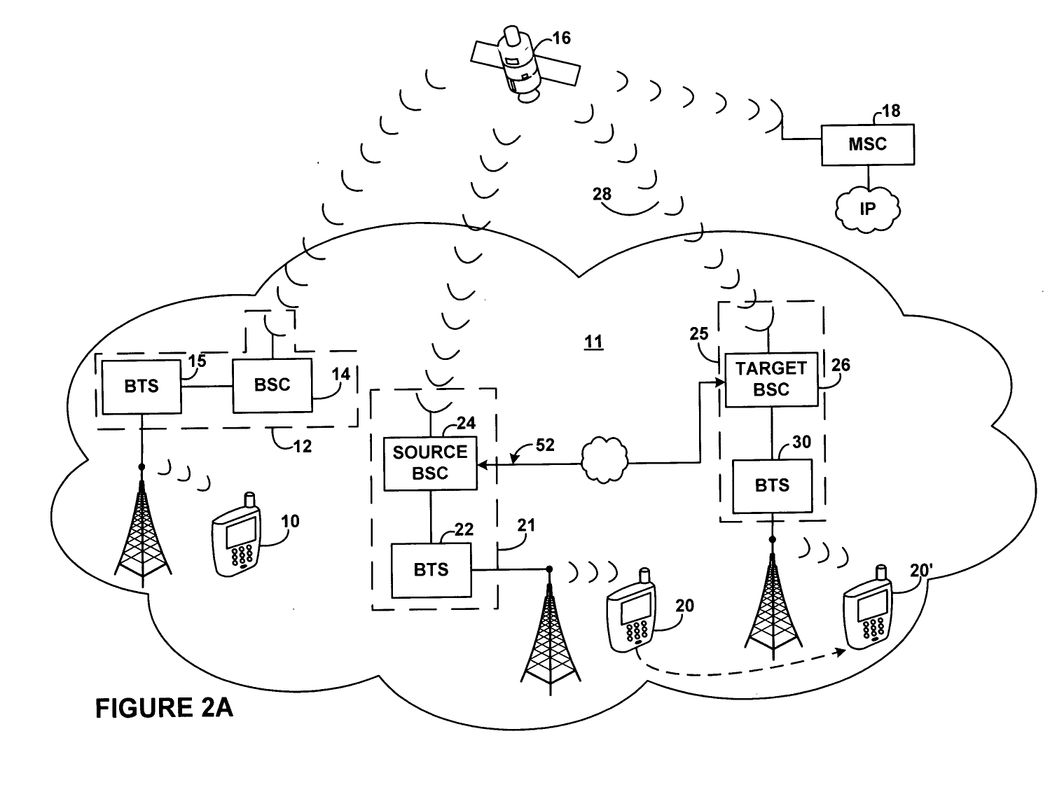

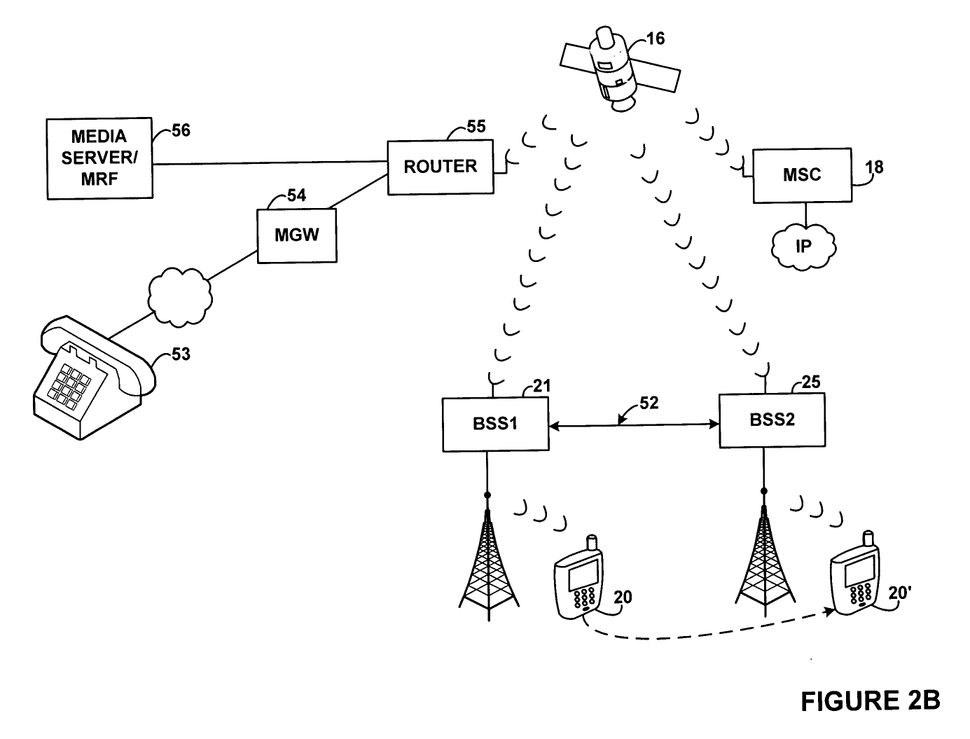

With reference to FIG. 2A, this invention provides for methods of seamless transmission of media traffic to a roaming mobile terminal in the event of an inter-BSC handoff from a first base station system (BSS1) 21 (“Source” BSS) to a second base station system (BSS2)(“Target” BSS) 25 due to roaming of the mobile terminal 20. The mobile terminal receives traffic from the remote media device, in this example a base station system 12. The remote media device 12 could take a variety of forms, such as a media gateway, media resource function, conference bridge, base station controller, or other. The roaming is indicated by the arrow and the change in the position of the mobile terminal at 20 and 20′.

In a first aspect, the method involves having the first base station system BSS1 21 re-direct any incoming media after the inter-BSC handoff occurs to the second base station system BSS2 25, until the media from the remote base station system 12 or remote media device starts arriving at the second base station system BSS2 25. Such routing is indicated by the communications path indicated at 52 in FIG. 2A. This embodiment appreciates that a delay in forwarding new routing information to the MSC 18 and from there to the remote BSC 14 (or media gateway or other media equipment) will result in some media traffic being sent to the first base station system BSS1 21 after the handoff has occurred. Any such traffic that is received at the first base station BSS1 21 is forwarded to the second base station system BSS2 25.

This particular embodiment takes advantage of a communication path 52 (e.g. LAN, WAN, microwave link, or other) between the first and second base station systems BSS1 (21) and BSS2 (25) as shown in FIG. 2A. Such path 52 will typically be present in wireless service provider implementations in which multiple base station controllers are linked together via a LAN or other type of high-speed network. Such a network may be configured as an Internet Protocol network.

In this embodiment, and with continued reference to FIG. 2A, a method for seamless transmission of media traffic to a roaming mobile terminal in the event of a handoff from a first base station system (“BSS1”)(21) to a second base station system (“BSS2”) (25) due to roaming of the mobile terminal comprises the steps of:

(1) establishing a channel at the second base station system BSS2 (25) with the mobile terminal 20′ in response to the handoff to the second base station system BSS2 (the radio channel at the BSC 24 of BSS1 (21) is torn down as usual in response to the handoff);

(2) setting up two incoming media ports (not shown) at the base station controller 26 in the second base station system BSS2, the first of which (Port 1) comprise a media port to receive traffic from the first base station system BSS1 (21) and the second of which (Port 2) comprises a media port to receive traffic from the remote base station system (12) or remote media source. The Source BSC 24 in BSS1 (21) is instructed to route any incoming media packets for the torn down connection to Port 1 on the Target BSC (26). An optional timeout timer is set up at this point limiting the period of time in which the Source BSS 1 (21) forwards packets to Port 1.

(3) receiving, at the second base station controller (BSC 26), any traffic received at the first base station controller (BSC 24) at the Port 1; and

(4) forwarding media traffic received on the first media port (Port 1) and the second media port (Port 2) of the second base station controller (BSC 26) to the mobile terminal 20′ via the BTS 30. The second base station controller (BSC 26) treats media traffic (packets) received at either port 1 or port 2 as if they were received on a single port.

In one particular embodiment, the BSC 26 in second base station system BSS2 tears down (i.e., releases) the first port after a configurable time period T elapses after the first port is established. In one variation, the BSC 26 tears down the first port after a configurable time period T elapses after the traffic starts arriving from the second port (directly from the remote end 12). T may for example by the length (duration) of the jitter buffer on the BSC 26 of the Target BSS2.

Similarly, the BSC 24 may tear down its connection to BSC 26 along signal path 52 after some configurable time period T elapses.

The coordination of forwarding media traffic from BSC 24 to BSC 26 is via the MSC 18. In particular, after mobile terminal 20 registers with BSC 26, BSC 26 sends its IP address and port number for the first port to the MSC 18. The MSC 18 forwards the IP address and port number to the BSC 24. BSC 24 uses the IP address and port number to forward any further media traffic received from the BSC 14 (remote base station system 12) to the target BSC 26.

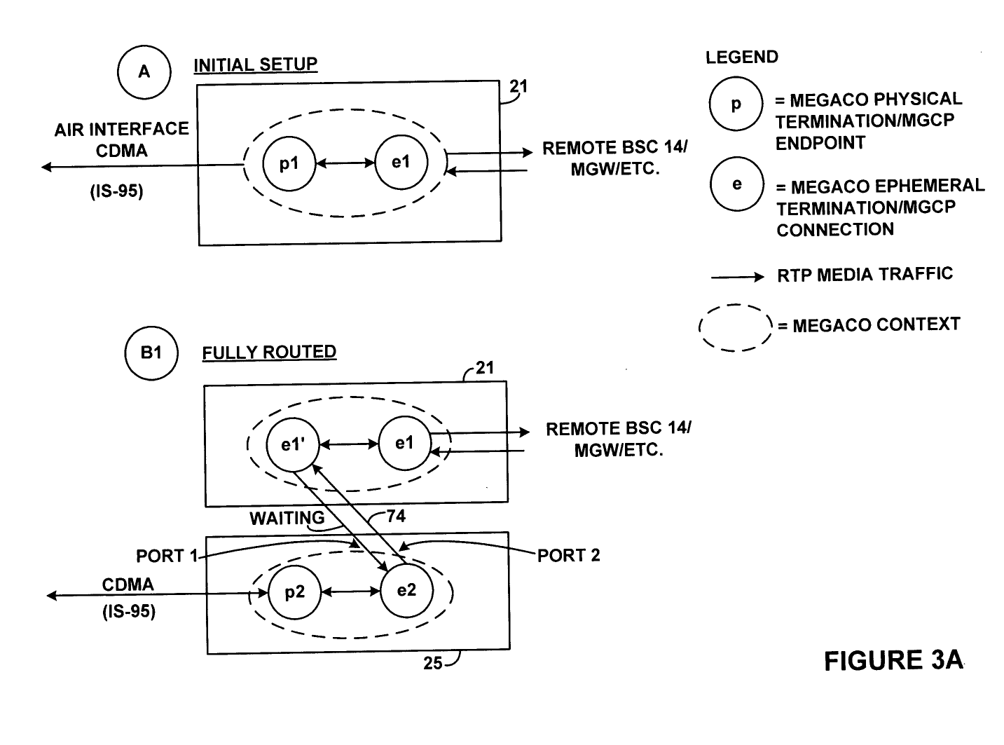

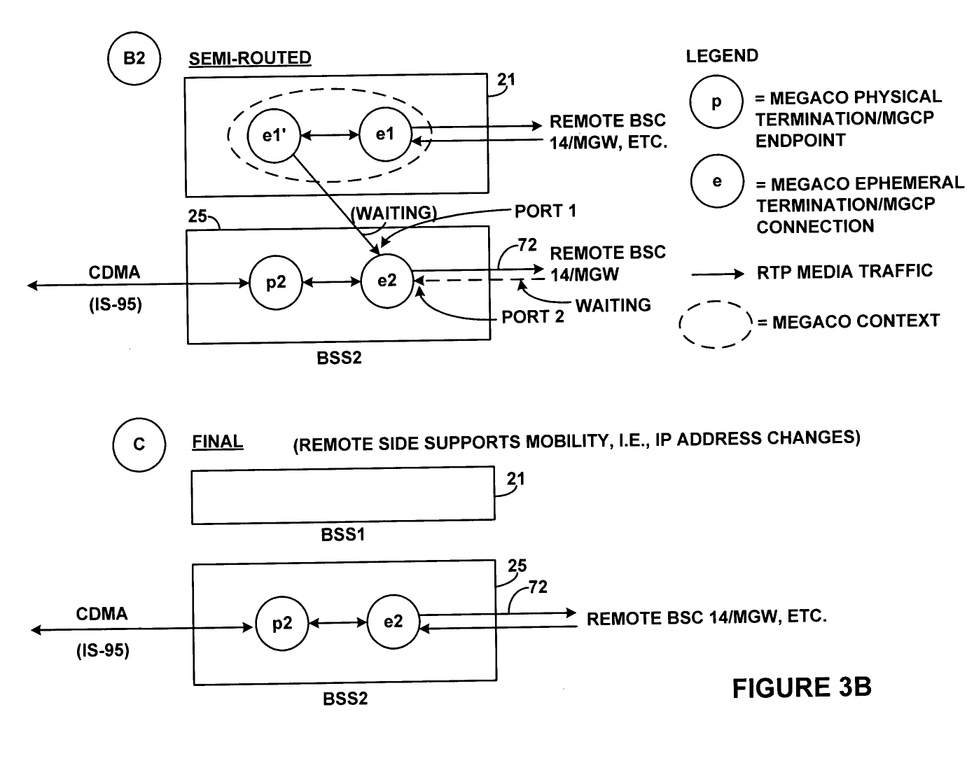

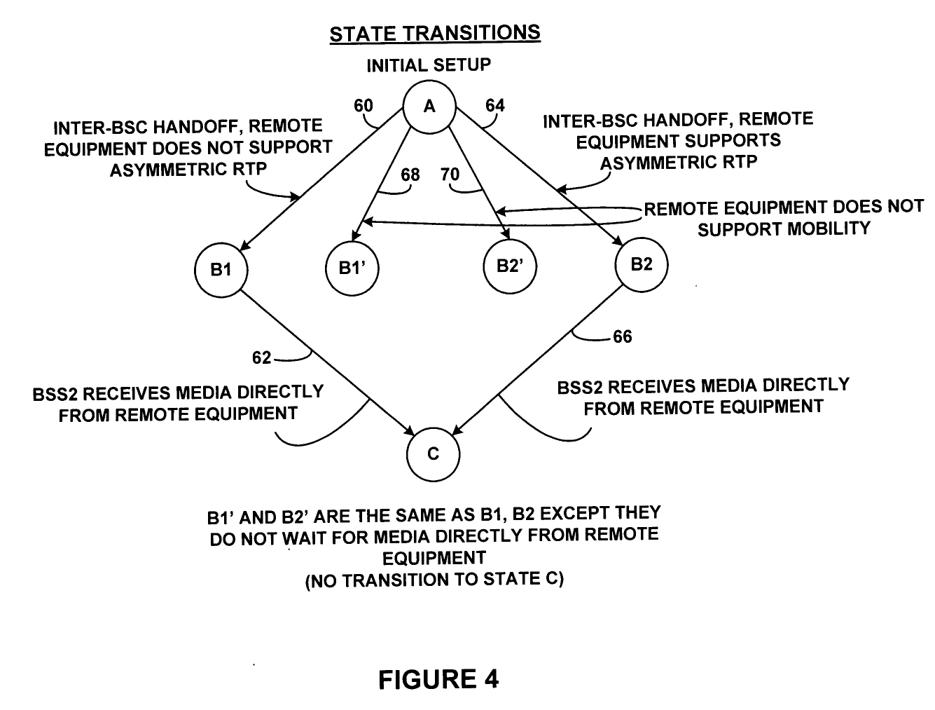

In one embodiment, in the event that the remote media device (e.g., base station system 12) is configured to handle an asymmetric Real-time Transport Protocol (one in which different source and destination addresses for RTP traffic are present for the far end of RTP traffic), the second base station system BSS2 (25) forwards media traffic packets from the mobile terminal 20 destined for the remote base station system 12 (i.e., traffic in the reverse direction) in a traffic path wherein the first base station system BSS1 (21) is not in the traffic path. In other words, traffic in the reverse direction can be transmitted from the second base station system directly to the remote base station system 12. (State B1 in the state diagrams of FIGS. 3A and 4 discussed below).

In some embodiments, the remote base station 12 or media source may not be configured to handle asymmetric Real-time Transport Protocol traffic, or another device in the media path, such as a firewall, may block asymmetric operation. In this situation, the second base station system BSS2 forwards packets from the mobile terminal 20 destined for the remote base station system 12 (i.e., reverse direction traffic) in a traffic path wherein the first base station controller (BSC 24) is in the traffic path. In other words, for the remote base station system 12, the source and destination address for the same end of the RTP traffic is the same—i.e., that of the first base station system (21), and more particularly a port on the BSC 24. The traffic is routed to and from BSS2 through BSC 24 (State B1, “fully routed” in the state diagrams of FIGS. 3B and 4 discussed below).

FIG. 2B is an illustration of an embodiment with a router 55 which forwards media traffic from a source 53 (which may comprise a telephone or any data terminal) to a roaming mobile terminal 20. The router may also forward media from a media server 56 or other entity connected to it such as a media resource function (MRF). The term media server 56 refers to any equipment that acts as a source of RTP media (e.g., announcements, conference mixing, etc.). The media server 56 (or one of the entities connected to it such as the mobile resource function (MRF) or the media gateway (MGW) 54 does not support mobility, in particular the ability to change destination IP addresses after a session has commenced. The mobility of the roaming mobile terminal 20/20′ is hidden from the remote media equipment 54/56 by use of the forwarding function performed at the first base station system 21.

FIGS. 3A and 3B are illustrations of the states of Media Gateway Control Protocol (MEGACO) physical and ephemeral terminations in the first and second base station systems providing for a seamless transition of media traffic during handoff using the features of FIGS. 2A and 2B. The state transitions are also shown with further explanation in FIG. 4.

In state A (initial set-up, mobile terminal 20 becomes registered with BSC 24 of BSS1), the BSS1 21 establishes a Media Gateway Control Protocol (MEGACO) (H.248) physical termination or endpoint p1 and a MEGACO ephemeral termination or connection e1 with the remote equipment, i.e., BSC 14 of the remote BSS 12 (FIG. 2A) or the media gateway, RTF or Media Server of FIG. 2B. In other words, BSC 24 establishes an RTP connection with the BSC 14 or remote media equipment. The BSC 24 also establishes a connection between an RTP port pair on the BSC 24 and the mobile terminal 20.

After the initial setup, the mobile terminal 20 roams to a new area served by a BSC 26 of BSS2 (25, FIGS. 2A, 2B). An inter-BSC handoff between BSS1 21 and BSS2 25 then occurs. When the mobile registers with the BSC 26 of BSS2, the IP address of the BSC 26 and the port number allocated at the BSC 26 of BSS2 is forwarded to the MSC 18 and it forwards the IP address and port number to the BSC 24 of BSS1 (21). If the remote equipment (BSC 14, Media Gateway, Media Server, etc.) does not support asymmetric RTP, the State B1 is entered (“fully routed”). In this state, the BSS1 21 establishes a second MEGACO ephemeral termination e1′ which forwards media traffic from the remote equipment to the port (“port 1”) of the BSC 26 in BSS2. The media traffic is received at a MEGACO ephemeral termination e2 at the BSC 26 of BSS2, which forwards the traffic to the MECACO physical termination P2. Media traffic is forwarded by the BSC 25 to the mobile terminal via BTS 30 in accordance with CDMA (IS-95) protocol. CDMA media traffic in the reverse direction is passed from physical termination p2 to ephemeral termination e2, passed from e2 to the BSC 24 in BSS1 where it is received by ephemeral termination e1′, passed to e1 and then sent to the remote BSC 14 , etc. as shown in state B1 of FIG. 3A.

While termination e2 receives media on port 1, the BSC 26 also listens for RTP packets on another port (port 2) arriving directly from the remote media equipment. After packets start to be received on the port 2, the system transitions to the final state (state C, FIG. 3B). If the remote equipment supports mobility, state C is entered (MEGACO physical and ephemeral connections are torn down at the BSC 24 of BSS1, MEGACO physical and ephemeral terminations p2 and e2 in BSC 26 handle traffic as shown in FIG. 3B, port 1 is torn down at the BSC 26 in BSS2).

If the remote equipment does not support mobility, and if the remote equipment does not support asymmetrical RTP, the BSS1 and BSS2 entities remain in state B1′ (FIG. 4).

In the situation where there is an inter-BSC handoff, and the remote equipment supports asymmetrical RTP, the state B2 (FIGS. 3B, 4) is entered after state A instead of state B1. In state B2, BSS1 continues its MEGACO ephemeral terminations e1 and e1′ and routes/relays any media data it receives to port 1 of the BSC 26 in BSS2. BSS2 establishes port 1 upon registration of the mobile terminal 20. The BSC 26 in BSS2 also establishes a second port (port 2). Port 2 is established for receiving media traffic directly from the remote media equipment (i.e., traffic that does not go through BSS1). While termination e2 receives media on port 1, it also listens for RTP packets on port 2. After packets start to be received on the port 2, the system transitions to the final state (state C, FIG. 3B, FIG. 4). In state C, MEGACO physical and ephemeral connections are torn down at BSS1, MEGACO physical and ephemeral terminations p2 and e2 at BSC 26 in BSS2 handle traffic as shown in FIG. 3C, state C). The BSC 26 in BSS2 further tears down (releases) port 1.

In the event that the remote equipment does not support mobility, but does support asymmetrical RTP, the system remains in state B2′. Traffic in the reverse direction is routed via e2 out port 2 at the BSC 26 in BSS2 to the remote equipment (BSC 12/media gateway, media server).

From the above discussion, in view of FIG. 2A, it can be seen that in the event that the remote base station system 12 is configured to handle an asymmetric real-time transport protocol, the second base station system BSS2 forwards packets from the mobile terminal destined for the remote base station 12 system in a traffic path wherein the first base station BSS1 is not in the traffic path. This is indicated in FIG. 3B, state B2, at 72.

Conversely, in the event that the remote base station system 12 is not configured to handle an asymmetric real-time transport protocol, the second base station system BSS2 forwards packets from the mobile terminal destined for the remote base station system in a traffic path wherein the first base station system BSS1 is in the traffic path. This is indicated in FIG. 3A, state B1, at 74 (traffic may pass along communication path 52 of FIG. 2A).

The process described above in FIGS. 3A, 3B and 4 can be adapted to traffic from a media server or other remote equipment that does not handle mobility, i.e., cannot be dynamically reconfigured to send/receive media traffic to/from a new BSC when the mobile device is roaming between BSCs. When the media server does not support mobility of a device receiving the traffic, the states A and B1 or B2 are entered, but not state C (FIG. 4). In particular, the method for providing seamless communication to the mobile device includes a step of setting up a media port (port 1) at the BSC 26 of the second base station system BSS2, the media port for receiving traffic from the first base station system BSS1; directing any further incoming traffic received at the first base station system BSS1 to the media port at the base station controller of the second base station system BSS2; and forwarding media traffic received on the media port of the second base station system BSS2 to the mobile terminal, as shown in FIGS. 3A and 3B, states B1 or B2. In one embodiment, the BSC 26 of BSS2 does not establish a second port and instead receives all traffic via port 1. In other words, port 1 and port 2 may correspond to the same UDP port number. In another embodiment, where the remote equipment supports asymmetrical RTP, state B2 is entered, the BSC of BSS2 sets up a second port, and all traffic in the reverse direction is transmitted via the second port.

At the end of the call, the BSC of BSS1 is instructed to tear down its routing of media traffic to BSC of BSS2. Similarly, BSS2 releases port 1 at the end of the call (and releases port 2 at the end of the call if state B2 is entered).

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

I claim:

1. In a communications system having a remote media equipment and a mobile switching center, a method for seamless transmission of media traffic from said remote media equipment to a roaming mobile terminal in the event of an inter-Base Station Controller handoff from a first base station system to a second base station system due to roaming of the mobile terminal, said mobile terminal receiving media traffic from the remote media equipment, comprising the steps of:
establishing a channel at the second base station system with the mobile terminal in response to the handoff to the second base station system;
setting up two incoming media ports at a base station controller in the second base station system, the first of which comprise a media port to receive traffic from the first base station system and the second of which comprises a media port to receive traffic from the remote media equipment;
re-directing any incoming traffic received at the first base station system after the handoff to the first media port at the base station controller of the second base station system;
forwarding media traffic received on the first media port or the second media port of the base station controller of the second base station system to the mobile terminal.

2. The method of claim 1, wherein the base station controller of the second base station system tears down the first port after a configurable time period T elapses after said first port is established.

3. The method of claim 1, wherein the base station controller of the second base station system tears down the first port after a configurable time period T elapses after a first packet is received on said second port.

4. The method of claim 1, wherein, in the event that the remote media equipment is configured to handle an asymmetric real-time transport protocol, the second base station system forwards packets from the mobile terminal destined for the remote media equipment in a traffic path wherein the first base station system is not in the traffic path.

5. The method of claim 1, wherein, in the event that the remote base station system is not configured to handle an asymmetric real-time transport protocol, the second base station system forwards packets from the mobile terminal destined for the remote media equipment in a traffic path wherein the first base station system is in the traffic path.

6. The method of claim 1, wherein a signaling path between the first base station system and the mobile switching center includes a relatively slow or high-delay link.

7. The method of claim 6, wherein said signaling path includes a satellite link.

8. The method of claim 1, wherein the remote media equipment comprises a base station controller.

9. The method of claim 1, wherein the remote media equipment comprise a media gateway.

10. The method of claim 1, wherein the remote equipment comprises a media server.

11. In a communications system having a remote base station system and a mobile switching center, a method for seamless transmission of media traffic to a roaming mobile terminal in the event of an inter-Base Station Controller handoff from a first base station system to a second base station system due to roaming of the mobile terminal, the mobile terminal receiving traffic from a remote media equipment, wherein the remote media equipment does not support mobility of a device receiving the traffic, comprising the steps of:
setting up a media port at a base station controller of the second base station system, the media port for receiving traffic from the first base station system;
directing incoming media traffic received at the first base station system to the media port at the base station controller of the second base station system; and
forwarding media traffic received on the media port of the second base station system to the mobile terminal.

12. The method of claim 11, wherein the remote equipment comprises a media gateway.

13. The method of claim 11, wherein the remote equipment comprises a media resource function server.

14. The method of claim 11, wherein the remote equipment supports an asymmetric Real-time Transport Protocol and wherein traffic in the reverse direction from the mobile terminal to the remote equipment is transmitted in a media path which does not include the first base station system.
